(19) United States
(12) Patent Application Publication
(10) Pub. No.: US 2004/0173046 A1
(43) Pub. Date: Sep. 9, 2004

(54) Hand guard

(76) Inventors: Dennis Hancock, Mountain Green, UT (US); Jeffrey D. Hancock, Uintah, UT (US)

Correspondence Address: DENNIS HANCOCK, 5752 SILVERSTONE CIRCLE, MOUNTAIN GREEN, UT, 84050, US

(21) Appl. No.: 10/379,502

(22) Filed: Mar. 5, 2003

(51) Int. Cl. B62K 21/12

(52) U.S. Cl. 74/551.8

(57) ABSTRACT

A hand guard to be secured to the handlebar of an all terrain vehicle that includes a core of flat flexible plastic material sandwiched between a first outer fabric material and a second inner fabric material and of generally heart shape including a base portion extending inwardly from the small end of said body and lobes projecting from opposite sides and the end of said base portion to be bonded at the V of said heart shaped body to provide an inwardly cupped body; and strap means secured to the small end of the body to secure the small end of the body to a handlebar of a vehicle.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to hand guards for use with all terrain vehicles and intended to protect the hands of a user from injuries that might occur from flying objects, brush, tree limbs and other objects that might be encountered during use of an all terrain vehicle.

During use of all terrain vehicles off highway it is not uncommon for a user's hands that are grasping the handlebars of a vehicle to be contacted by rocks, sand and other debris that is frequently tossed in the air by other leading vehicles or even other vehicles operating in the same area. Even more frequently the hands of an operator of an all terrain vehicle, while grasping a handlebar are subject to being whipped by brush and tree limbs as the vehicle travels, frequently at rather high rates of speed. Further, in cold weather air rushing past an all terrain vehicle will often chill the hands of the operator.

### BRIEF SUMMARY OF THE INVENTION

Principal objects of the present invention are to provide a hand guard that is easily used with most off road vehicles having handlebars and that will provide protection for the operator of the vehicle from objects and wind that could otherwise injure the hand of the user or make the user's hand uncomfortable.

Another object is to provide a hand guard that will flex when subjected to sufficient impact but that will return to its assigned shape after such impact.

Other objects are to provide a hand guard that is easily attached to the handlebars of an off road vehicle and that can be readily and economically produced and marketed.

Principal features of the invention include the use of a single piece of generally heart shaped strong foam plastic sandwiched between fabric layers and with the composite of plastic and fabrics molded to provide a shield having a central base with a pair of lobes projecting from opposite sides and one end of the central base.

The hand guard is molded to bond together portions of the edges of the lobes extending beyond the one end of the base while providing flex folds along edges of the lobes and outwardly of the base intermediate the lengths of edges of the base.

An edging fabric is sewn around the edge of the lobe for appearance purposes and to prevent separation of the fabrics from the plastic material used. A strap is sewn, intermediate its length. across the curved smaller end of the hand guard to an outer surface thereof. A strap tightener is connected to one end of the strap and the other end of the strap sill reach around the hand guard and a vehicle handlebar. to be inserted through the strap tightener so that it can be pulled to tighten the small end of the hand grip around the handlebar. It will be apparent that other types of fasteners, such as hook and loop fasteners, can be used in place of the strap and strap tightener her described. The hand guard is positioned on a vehicle handlebar ahead of the vehicle handgrip by tightening the strap around the handlebar. So positioned the handgrip extends outwardly away from the vehicle and the outer face of the hand guard will deflect air and objects over, around and beneath a user's hand positioned on the hand grip.

Additional objects and features of the invention will become apparent to those skilled in the art to which the invention pertains from the following detailed description and drawings.

### BRIEF DESCRIPTION OF THE DRAWINGS

FIG. 1 is a perspective view of a pair of hand guards of the invention mounted on the handlebars of an all-terrain vehicle;

FIG. 2, a perspective view of the foam plastic hand guard of the invention;

FIG. 3, an inside plan view of the hand guard;

FIG. 4, an outside plan view; and

FIG. 5, a rear end elevation view,

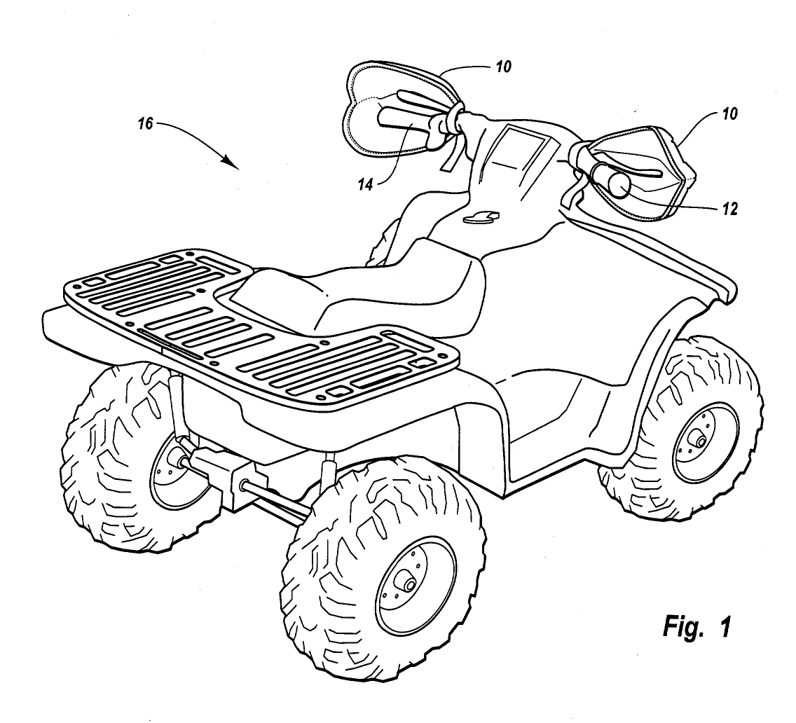

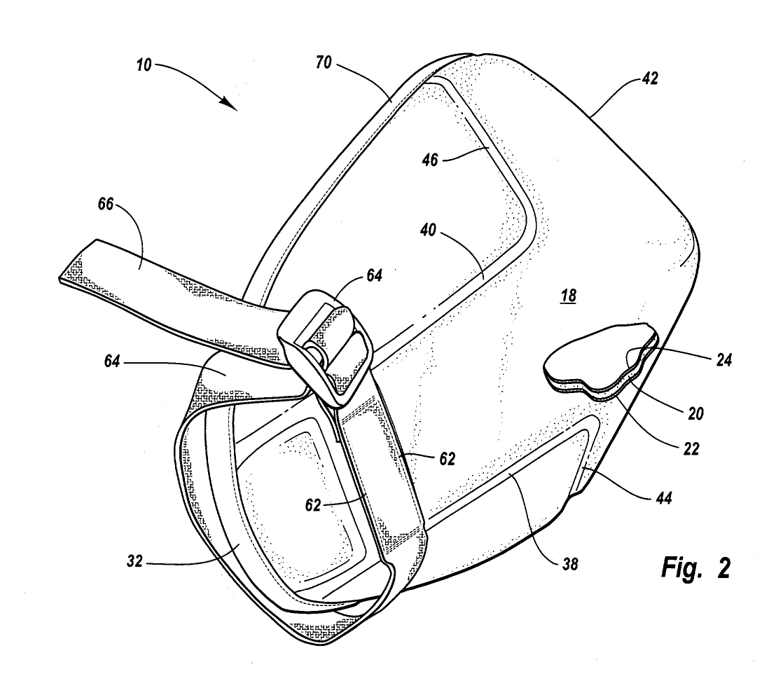

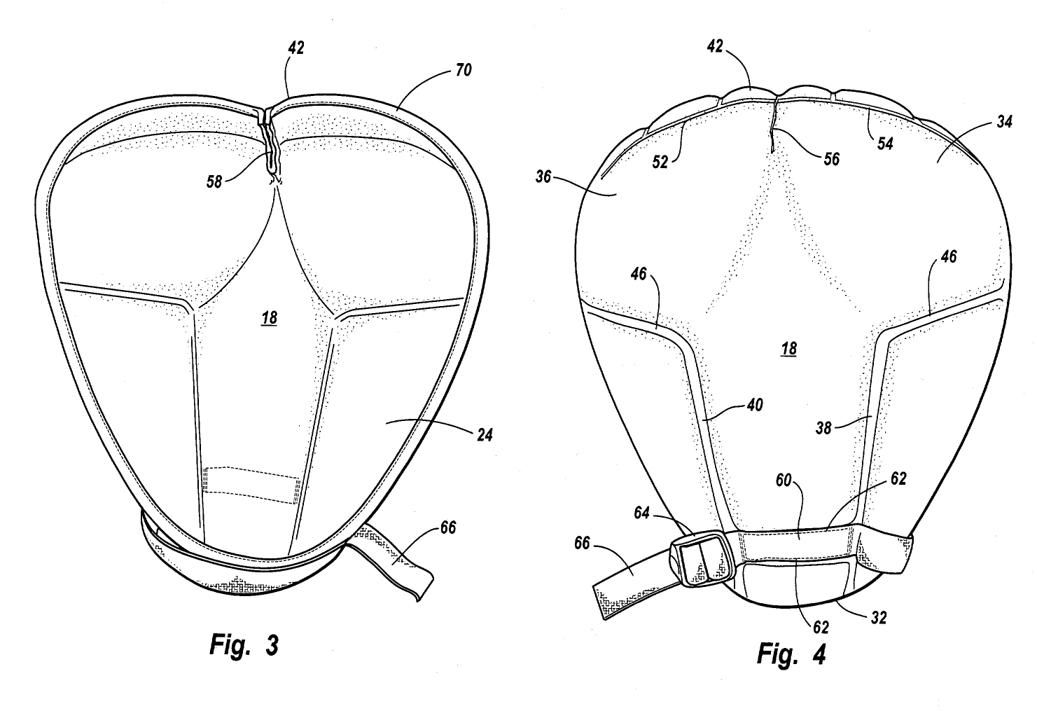

### DETAILED DESCRIPTION OF THE INVENTION

Referring now to the drawings:

In the illustrated preferred embodiment a pair of the hand guards 10 are shown mounted on handlebars 12 and 14 of an all-terrain vehicle, shown generally at 16. Hand guard 10 includes a body 18 having a core 20 made of a suitable flexible plastic material, such as urethane plastic. An outside fabric layer 22 and an inside fabric layer 24 are sandwiched together with the core 20 to form the composite body 18. Body 18 has a generally heart shape, with a small end 32 and a pair of side lobes 34 and 36. Body 18 is molded to desired shape with heat and pressure on outside fabric layer 22 to form spaced apart bending grooves 38 and 40 extending from small end 32 towards an outer large end 42.

Additional bending grooves 44 and 46 are respectively formed to flare outwardly from the ends of grooves 38 and 40 to the edges 48 and 60 of the lobes 34 and 36. Other bending grooves 52 and 54 are formed to extend across each of the respective large ends of the lobes 34 and 36, outside the junction 56 of the lobes 34 and 36. Spaced apart bending grooves 48 and 50 extend from each of the grooves 42 and 44 to the edge of a lobe.

The lobes 34 and 36 are pulled together at the large end of the hand guard during molding and the plastic at opposite sides of the V of the heart shaped body 18 are bonded together at 58 for a portion of the V. Bonding of the V edges cups the hand guard by bending the body along each of the bending grooves at the large end of the hand guard. The cupped shape insures fitting of the hand guard over the hand and lower arm of an all-terrain vehicle user when the hand guard is mounted on such vehicle.

A strap 60 is sewn at 62, intermediate its length, across the body 18 at a spaced distance from the small end 32. A strap tightener 64 is fixed to one end 66 of strap 60 and the strap is sufficiently long to pass around the small end of body 18 and a handlebar positioned within the wrapped small end 32 before strap end 66 is passed through the strap tightener. Pulling on the end 66 will secure the hand guard 10 to a vehicle handlebar.

A fabric strip 70 is folded over the edge of body 18 and is sewn to the edge to prevent separation of the composite layers of the body.

Although a preferred embodiment of the invention has been herein disclosed, it is to be understood that such disclosure is by way of example and that other variations are possible without departing from the subject matter coming within the scope of the following claims, which subject matter we regard as our invention.

We claim:

1. A hand guard for use on all terrain vehicles comprising
a body formed of a core of plastic material sandwiched between a first outer fabric and a second inner fabric and having a generally heart shaped configuration when flat and molded to have a base portion extending from a small end of the body and lobes projecting from opposite sides of said base and beyond said base and with outer edges of said body cupped inwardly and secured by bonding of said plastic core in each lobe being bonded together at a V of said heart shaped body; and
strap means secured to said body across said small end and including a strap and encircling said small end and securement means to interconnect ends of said strap.

2. A hand guard as in claim 1, further including
a fabric strip surrounding said body and sewn thereto to prevent separation of said plastic core and said inner and outer fabrics.

3. A hand guard as in claim 1, wherein
the body has grooves pressed into the outer fabric and core and extending from the base outwardly to edges of the lobes, as cords across the lobes at the large end of said body and from said cords to the edges of said lobes at said large end of said lobes to provide for cupping of said body.
